(19) United States
(12) Patent Application Publication
(10) Pub. No.: US 2005/0057116 A1
(43) Pub. Date: Mar. 17, 2005

(54) Electrical power source

(76) Inventors: Patrick Cornille, rue de la Pommeraie (FR); Jean-Louis Naudin, Rue Des Porettes (FR)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/472,714

(22) PCT Filed: Mar. 20, 2002
(86) PCT No.: PCT/FR02/00982

(30) Foreign Application Priority Data
Mar. 21, 2001 (FR) 0104130

(51) Int. Cl. H02N 1/00

(52) U.S. Cl. 310/309

(57) ABSTRACT

An electric energy source is made by means of a plate capacitor in interposing a set of plasma tubes between the plates. The assembly is subjected to cycles for the charging of the capacitor. These cycles comprise the excitation and the de-excitation of the gas of the plasma tubes. It is shown that the device has an efficiency of more than one.

### BACKGROUND OF THE INVENTION

An object of the invention is an electric energy source. The aim of the invention is to propose a source of electric energy, i.e. a generator, of exceptional efficiency. The generator is of the type using discharge capacitors, especially repetitive discharge capacitors. The efficiency depends on the discharging frequency of the capacitor and on the number of charging cycles performed. The energy source of the invention is designed to be fitted into fixed or moving apparatuses, as the generator is easily transportable and is also autonomous.

To understand the mode of operation of this invention, a few well-known principles of classical physics need to be recalled. If a metal plate capacitor is charged by means of a voltage source, and if the metal plates are moved away from each other after the capacitor has been disconnected from its source through a switch, there is an increase in voltage at the terminals of the capacitor resulting from the law of conservation of charge Q=CV.

This operation can be performed symmetrically through the use (as shown in FIG. 1) of an assembly of two capacitors CP1 and CP2. The two capacitors CP1 and CP2 are plate capacitors. They are series-connected by means of an electric connection. These capacitors CP1 and CP2 have external plates facing the outside of the assembly, and internal plates facing the inside of the assembly. The internal plates of the two capacitors are connected to each other electrically by the electric connection. The external plates are fixed and are located at a great distance from each other when compared with the distance between the internal plates and the external plates in each capacitor. A switch S1 connects the external plates conditionally to a direct-current power supply HT1.

The internal plates are moveable. When they are removed, after the switch S1 has been opened, there is an increase in electrostatic energy that is localized in the capacitor formed by the remaining external electrodes. The system is therefore an energy multiplier. This increase in energy is given by the work of the observer who performs the maneuver of removing the internal plates. It is known that the law of conservation of energy is met since the electrostatic forces verify Newton's third principle. Consequently, the efficiency of the operation cannot exceed 100%. The operation of removing the plates can be done rotationally by means of an electric motor as described in the document U.S. Pat. No. 4,127,804, by Breaux, published on 28 Nov., 1978. In this document, it is sought to minimize the mechanical work by taking capacitors in which the position of the internal plate is offset by 90 degrees. A scheme of this kind does not totally eliminate the resistant electrostatic forces and the gain is obtained to the detriment of the multiplication of energy in the capacitors since the capacitance of each capacitor at the initial point in time is no longer equal.

In physics, there are two types of capacitors: capacitors of a first type, which are capacitors with total influence like the spherical capacitor, and capacitors of a second type with partial influence like the plate capacitor. The document by Hiddink, U.S. Pat. No. 4,095,162, published on 13 Jun. 1978, describes a capacitor of the first type in which the internal electrode of the spherical capacitor is replaced by a plasma chamber in order to increase the potential of the external electrode. According to the authors of this document, the charge carried to the surface of the external electrode is small or negligible. Tests based on this approach have not given the conclusive results that were proclaimed.

In the invention, to increase efficiency, the structure of the Breaux document has been modified by replacing the internal plates by two plasma chambers bonded to the interior of the external faces of a plane capacitor of the second type. As a consequence, the internal metal plates of the two series-mounted capacitors of FIG. 1 are replaced by chambers containing a gas that can be ionized by applying a high voltage. As a variant, a single plasma chamber extends from one internal plate to the other, setting up an electric connection at the same time. A second configuration using four plasma chambers can be envisaged. The second configuration simply increases the output energy from the system by a factor of two.

Further below, we shall how this structure enables a reduction in the work to be furnished in order to charge the external plates and hence increase the efficiency exceptionally.

### SUMMARY OF THE INVENTION

An object of the invention therefore is an electric energy source comprising:
a capacitor with two plates connected to two terminals of the source,
a conduction device interposed between the two plates,
   wherein the source comprises:
a circuit to make the conduction device conductive or non-conductive.

For its first charge, the two-plate capacitor may be connected to a DC voltage source.

An object of the invention is also an electric energy source comprising:
a capacitor with at least two metal plates facing each other and connected to two terminals of the source, and
means to charge this capacitor at high voltage,
   wherein the means to charge this metal plate capacitor at high voltage comprise:
a set of plasma plates positioned so as to be facing the metal plates,
these plasma plates being connected to a switch or selector switch circuit to periodically form a set of at least two series-connected capacitors each comprising a metal plate and a plasma plate.

### BRIEF DESCRIPTION OF THE DRAWINGS

The invention will be understood more clearly from the following description and the accompanying figures. These figures are given purely by way of an indication and in no way restrict the scope of the invention. Of these figures:

FIG. 1 which has already been commented upon describes a prior art electric generator;

FIG. 2 is a schematic view of an energy source according to the invention;

FIG. 3 is a practical assembly enabling a real implementation of the invention in the context of a simple example of use;

FIG. 4 are timing diagrams showing the succession of the commands applied to the different elements of the source of the invention and the results measured;

FIG. 5 shows an alternative embodiment of the source of FIG. 2;

FIGS. 6 and 7 are diametrical sectional views of alternative cylindrical embodiments of the plasma plate capacitors;

FIG. 8 is a timing diagram showing the measured reality of the phenomenon of the invention.

### MORE DETAILED DESCRIPTION

FIG. 2 shows an electric energy source according to the invention. This source has a capacitor 1 with two metal plates 2 and 3, made of aluminum for example. The two plates 2 and 3 are connected to two terminals, respectively 4 and 5, of the source. The two plates are furthermore normally electrically biased by a direct-current power supply 6 connected to the terminals 4 and 5. In one example, the plates 2 and 3 are at a distance of 30 cm from each other and the biased voltage given by the direct-current power supply 6 is 1000 volts. The electric field prevailing in the capacitor is then equal to 3333 volts per meter. A conduction device 7 is interposed between the two plates 2 and 3. In the example, the conduction device has a first plasma tube 8 and a second plasma tube 9. These tubes 8 and 9 are, for example, tubes filled with an inert gas after being vacuumed. For example the gas in the tubes is neon, argon or any other rare gas or mixture of rare gases of this type. The pressure therein is low, for example in the range of 150 Torrs. The tubes are made of an insulating material, for example glass. The tubes have electrodes at their end. For example, the tube 8 has electrodes 10 and 11 and the tube 9 has electrodes 12 and 13. The electrodes emerge from the tubes and enable the gases contained in the tubes to be subjected to voltage differences.

To this end, the electrodes 11 and 12 are connected together by a connection 14, while the electrodes 10 and 13 are connected to the two poles of an electric biasing source 15. To simplify the explanation, it may be considered that the electric biasing source 15 is a source of direct-current voltage 16, connected as required to the electrodes 10 and 13 by a switch represented schematically at 17, or by a set of switches. The voltage produced by the direct-current voltage source 16 is equal for example to 15,000 volts. The direct-current power supply 6 is furthermore connected to the plates 2 and 3 by a switch shown schematically at 18.

The invention works as follows. With the switch 17 open, in the absence of voltage, the gas contained in the chambers 8 and 9 behaves like a dielectric medium, namely like an insulator. However, this gas becomes a conductive medium when it is ionized by the application of a high voltage, produced by the source 16 and applied by means of the switch 17. The conduction circuit of the invention is thus formed by the tubes 8 and 9 and by the connection 14. The circuit used to make the conduction circuit conductive is thus formed by the source 16 and by the switch 17.

Once the plasma is created in the chambers, and while the switch 17 remains closed, the two external metal electrodes 2 and 3 are charged by the source 6. In practice, the switch 18 is closed. This charging induces opposite-sign charges on the interfaces located between the glass wall of the chambers and the plasma. When the voltages applied to the external electrodes 2 and 3 and to the chambers 8 and 9 are cut off by the opening of the switches 17 and 18, firstly the gases contained in these chambers become insulating again, and then, secondly, the work that was performed by external observer in the mechanical withdrawal system described here above with reference to the document U.S. Pat. No. 4,127,804 is performed. This work is almost free in terms of energy contributed because it is produced by Coulomb forces inside the plasma at a distance that is in the range of a few Debye lengths λD=69 (Te/ne)^{1/2} in meters for a temperature Te in ° K, when Te represents the electron temperature and ne represents the electron density in the plasma.

Indeed, it is known that the plasma neutralizes a spatial variation of the charge in a few Debye lengths. This approach gives a gain in efficiency of the system since the work is done on a very short distance whereas, for a mechanical system, the work is done on the distance between the external plates of the capacitor. It must be noted that it is not possible to contribute energy coming from the generator that feeds the plasma since this energy is cut off during the phase of return from the plasma to an insulating medium. The energy balance of the system shall be examined further below. It will take account of the fact that energy has to be consumed to create a plasma.

In the case of a plane capacitor with a surface area S comprising p isotropic dielectric blades with a thickness ak and a relative permittivity ∈ᵣₖ, between its two electrodes, the formula that explains the value of capacitance of the capacitor has the following definition:
C=∈₀. S/aₘ

In this expression, ∈₀ is the permittivity of the vacuum and is equal to 10⁻⁹/36Π in international system units, and aₘ represents a mean thickness which has the following expression:

$${a}_{m} = {\sum }_{k = 1}^{p} \frac{{a}_{k}}{ɛ rk} \qquad formula 2$$

For glass, we have ∈ᵣ=4 and for air ∈ᵣ=1. It will be assumed that the relative permittivity of a non-ionized gas is that of air. The formula 2 furthermore shows the value of doping the glass with a certain percentage of barium titanate powder whose relative permittivity is ∈ᵣ=1800.

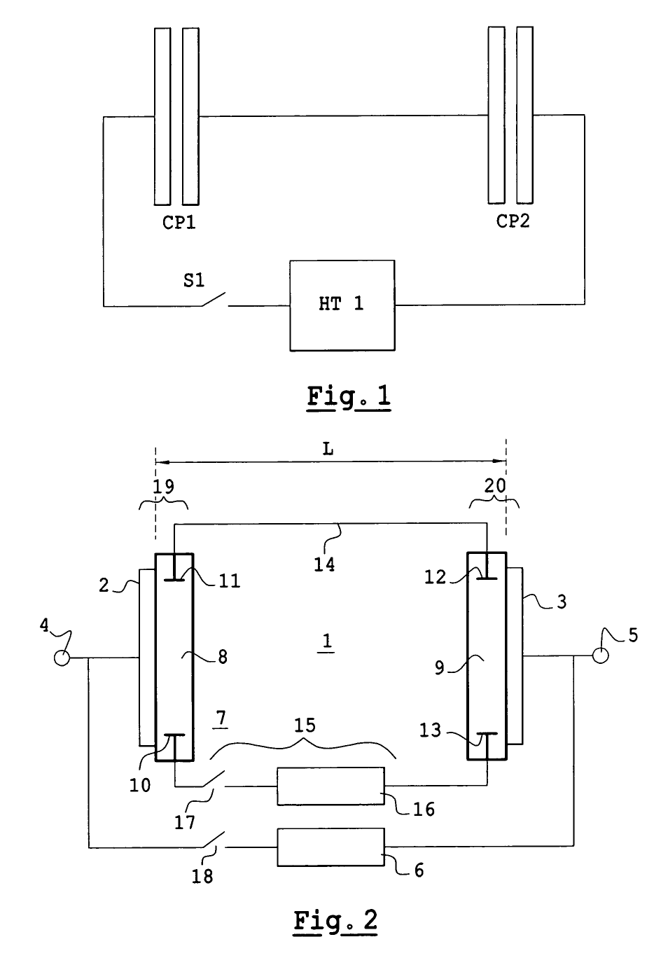

The invention achieves the result wherein two series-connected capacitors 19 and 20 such as the capacitors CP1 and CP2 in FIG. 1 are obtained. Each capacitor is formed by a plate, 2 or 3, of the capacitor 1 and a conductive sheet resulting from the presence of ionized gas in a tube, respectively 8 and 9. Each interior electrode of the capacitor of FIG. 1 is thus replaced by a parallelepiped-shaped chamber with the surface area S according to the arrangement of FIG. 2. When the plasma is ionized, it becomes a conductive medium that replaces the second metal plate of each capacitor. The thickness of the glass of the chamber is a. This thickness forms the distance between the conductive sheet since the tubes 8 and 9 are placed flat against the plates 2 and 3. The result of this is that the capacitance C of each capacitor 19 or 20 (assuming that they are built identically) has the following expression:
C=∈₀.∈ᵣ.S/a formula 3

For ∈ᵣ=4, a thickness of the glass a=1 mm and a surface area S=0.1 m2 (about 30 cm by 30 cm), a capacitance of C=3.5 nF is obtained for each capacitor 19 or 20.

Since there are two series-connected capacitors 19 and 20, the value of the equivalent capacitance C1 of these two series-connected capacitors, at an initial instant in which the charging of the global capacitor begins, is C1=C/2.

It is seen to it that the distance L=pa between the two external metal plates 2 and 3 is a multiple of a. Consequently, when the plasma in each chamber again becomes an insulating medium, a capacitor C2 formed by the two external metal plates and the different dielectric blades now has the value:
C2=∈₀.S/aₘ formula 4
With the definition aₘ=4a/∈ᵣ+(p−4)a formula 5

whence the ratio
β=C1/C2=2+(p−4 ).∈ᵣ/2 formula 5

It will be noted that β is far greater than 1. By using a method of this kind, it is possible to obtain a major multiplier factor. Thus, for the example where p=300, β has the value of 590. In fact, the voltage at the terminals 4 and 5 increases sharply. To avoid overvoltage in the source 6, it is planned either to open the switch 18 when the switch 17 is opened, or as a variant or preferably, as a complement, to place electric valves, preferably diodes, between the terminals 4 and 5 and the power supply 6.

Since the charge Q is kept in the transformation, the following equality is verified:
Q=C1.V1=C2.V2 formula 7

which implies the relationship
V2=β.V1 formula 8
confirming the rise in voltage.

Thus, the transformation leads to a rise in the initial voltage V1 applied to the two series-connected capacitors 19 and 20. It must also be noted that the value of the electric field between the electrodes of the capacitors does not get modified when the plasma gets converted from a conductive medium to an insulating medium. However, it is noted that the electric field is now deployed throughout the space between the two tubes 8 and 9 whereas, previously, a zero electric field was observed therein. Furthermore, the switching time for changing the medium is very short, in the range of few microseconds.

The values of electrostatic energy stored by the capacitors C1 and C2 are given by the relationships:

$$E1 = \frac{1}{2} C1 . {V1}^{2} = \frac{1}{2} {Q}^{2} / C1 et E2 = \frac{1}{2} C2 . {V2}^{2} = \frac{1}{2} {Q}^{2} / C2 \qquad formula 9$$

This results in a multiplication of the energy
E2=β.E1 formula 10

It is known that the energy consumed Ec=Q²/C1 by the high-voltage source to charge the capacitor C1 is at best twice the electrostatic energy given in C1. Indeed, the source 6 must have an internal impedance value adapted to that of the charge constituted by the capacitor C1 so that the efficiency of the charge is the optimum. In this case, an optimum efficiency is half. However, the energy at the end of the conversion is given by the energy present in the capacitor C2, namely E2=Q²/2.C2. It follows that the real gain in energy in the transformation is given by the formula:
γ=E2/Ec=β/2>>1 formula 11

We may refer now to the pressure in the plasma tube. The pressure P of a non-ionized gas contained in a chamber is given by the law of perfect gases:
P=n.k_{b}.T formula 12

where n is the density and T is the temperature of the neutral atoms contained in the chamber. In SI units, the Boltzmann constant k_{b} has the value k_{b}=1.38 10⁻²³ J/° K. At ambient temperature T=300° K, the Torr pressure of the gas in the chamber has the following value, given that 1 Torr=1.333 10² N/ m²:
P=3.1 10⁻²³n which implies n=3.2 10²²P formula 13

If α=nₑ/n is the rate of ionization of the gas, which is a value ranging from 10⁻⁸ to 10⁻⁷, the electronic density of the ne plasma in units m⁻in the chamber is given by the relationship:
nₑ=α/n=3,2 10²²α.P formula 14

For a parallelepiped-shaped chamber with a surface area S and a thickness d, the number of electrons contained in the chamber has the following value:
Nₑ=S.d.nₑ formula 15

For a plane capacitor with a surface area S, the charge Q localized on a plate is given by the formula Q=CV where V is the voltage applied between the two metal plates that form the capacitor. It follows that the number of charges present in each plate has the following value:
N=Q/q=C.V/q formula 16

where q=1.6 10⁻¹⁹ Coulomb is the charge in absolute value of the electron.

In the invention, each of the metal plates located within the external plates of FIG. 1 constituting two series-connected capacitors is replaced by a parallelepiped-shaped plasma chamber that simulates a conductive medium when the plasma is ionized. It is therefore necessary that the number of free electrons Ne in the plasma of each chamber should be greater than the number of charges N needed to charge the capacitors. It follows that the following inequality has to be rectified:
Nₑ=S.d.nₑ>N=C.V/q formula 17

The value of the capacitance C of each capacitor formed by the external metal plates and plasma chamber will be at most equal to:
C=∈₀.∈ᵣ.S/a formula 18

where a is the thickness of the glass wall of the chamber.

The formulae 14 to 18 make it possible to determine the minimum gas pressure, in Torr, to be set up in the chamber before ionization in order to obtain sufficient charges from the relationship:
P>1.7 10⁻¹⁵∈ᵣV/α.a.d formula 19

For a=0.1 cm, d=1 cm, ∈ᵣ=4 and V=V1/2=500 volts and α=10⁻⁸, a pressure of about 136 Torr is obtained.

We shall now examine the characteristics of the generator. If R is the internal resistance of the high-voltage source 16, the charging time constant of the capacitor C1 has a value T1=R.C1. If the capacitor is charged at the same time as the plasma is ionized, the period of time Ts of operation of the plasma is such that Ts>4T1 to create and maintain the plasma during the phase in which the capacitor C1 is charged. If Ps is the power put through by the voltage source 16, the energy consumed by the source 16 is Es=Ps.Ts enabling the computation of the efficiency of the system for a charging cycle:
α1=E2/(2E1+Es)=β.E1/(2E1+Es) formula 20

The above efficiency may be lower than or greater than one, depending on the operating time Ts of the system. To obtain efficiency greater than one, the following condition must be verified:
(β−2).E1>Ps.Ts formula 21

For a capacitor with a value C1=1.75 nF charged at a voltage of 1 kV, the charging energy for this capacitor has the value E1=C1.V1²/2=8.75 10⁻⁴ Joule. For a multiplier coefficient γ which is reasonably taken to be equal to 100, we obtain β=200. It follows that the final energy after multiplication is E2=200 E1=0.175 Joules.

The power necessary to ionize the plasma in the chambers is equal to 50 W. During the capacitor charging time which, in practice, is less than one ms, energy equal to Es=0.050 Joule is obtained. This energy is given by an external source. The efficiency of the entire system is then 338%. If the capacitor is discharged over a period of time of 1 ms, the electric power given by the system is 175 W.

This theoretical efficiency results from the energy given by the surrounding magnetic ether. It is set up on the basis of a theoretical β at 200 or even 590. However, owing to the existence of complementary phenomena such as offset, dielectric leakage, skin and other phenomena, a far smaller real result may appear, for example a resultant β of 10. In this case, the total efficiency may become smaller than one.

The amplification of the energy can then be considerably increased. To do so, instead of immediately discharging the capacitor C2, a second cycle is carried out for charging the capacitor C1. This time, it is no longer necessary to use the voltage source 6 since, when there is no discharge, the capacitor C2 at the end of the first cycle remains charged with the voltage V2. It is then sufficient to ignite the plasma chambers 8 and 9 a second time to recreate the capacitor C1 which is charged with the voltage V2. This results in the new conservation of the charge.
Q₀=C1.V2=C2.V3 formula 22

with the definitions
C=β.C2V3=βV2=μ²V1 formula 23

The energy values of the capacitors at the beginning and end of the second cycle are now:
E2=C1.V2²/2E3=C2.V3²/2 formula 24

The relationships 23 enable the energy to be written at the end of the second cycle in the form:
E3=C2.V3²/2=β³C1.V1²/2=β³E1 formula 25

The efficiency of the two cycles therefore has the following value:
α₂=β³E1/(2E1+2Ps.Ts) formula 26

A considerable increase is observed in efficiency. This efficiency will be all the greater if the following condition is now verified:
(β³−2)E1>2Ps.Ts formula 27

The computation of efficiency for n cycles can be generalized by applying a reasoning based on recurrence. The following formula is obtained:
αₙ=β²ⁿ⁻¹E1/(2E1+n Ps.Ts) formula 28

Such a process can soon lead to a voltage at the terminals of C2 that exceeds the disruptive potential in the air and is in the range of 30 000 volts per cm. In this case, either the entire device should be enclosed in a chamber in which there prevails a pressurized insulating gas, or the available energy should be consumed at the terminals 4 and 5. It must be noted that a device such as this can be likened to a Van de Graff electrostatic generator whose mode of operation is purely electronic.

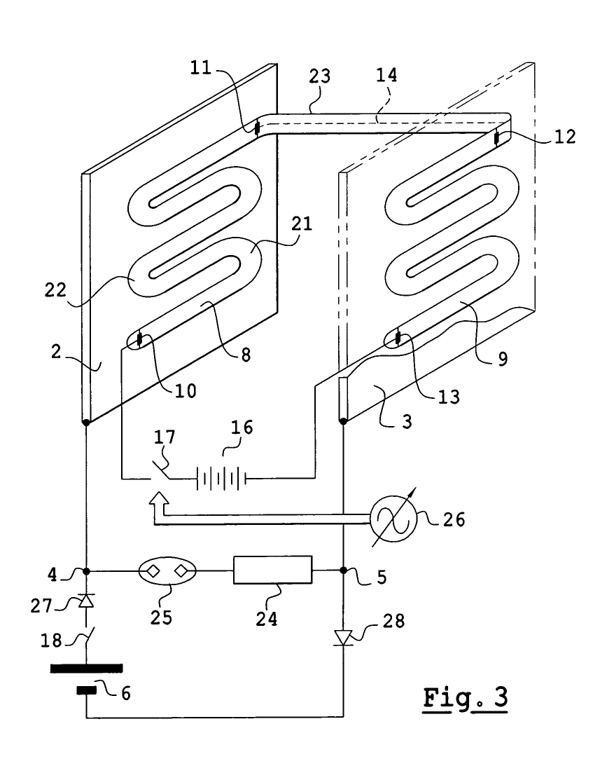

FIG. 3 repeats the elements of FIG. 2 in defining, firstly, the structure of the tubes 8 and 9 and, secondly, a circuit for the consumption of the energy produced. The tubes 8 and 9 thus take the form of serpentine tubes with meanders such as 21 and 22. These meanders are preferably contiguous and distributed so that they face surfaces of the plates 2 and 3 so as to cover the totality of these surfaces. In one example, each tube 8 or 9 is thus formed by 21 meanders such as 21. The above computations have been made on this assumption. Consequently, the plasma panel situated before each plate is formed by a stack of plasma bars, continually connected to each other by a plasma conduit. The two plasma panels 8 and 9 may be connected together by the electric connection 14, or by a link 23 made of plasma tube. In this case, the tube extends from the electrode 10 to the electrodes 13, the electrodes 11 and 12 being absent. On the contrary, the meanders may be replaced by a succession of tubes in series, each with a set of electrodes, an output electrode of a tube being electrically connected to an input electrode of a following tube. Any other arrangement of the meanders and of the bars can be envisaged. It is dictated by the voltage used for the ionization of the gases and the voltage available at the source 16. In particular, all the meanders of the two capacitors can be replaced by two sets of tubes in parallel, the two sets being series-connected by connection such as 14 or 23.

The circuit has a resistive load 24 or a transformer connected by means of a spark gap 25 to the terminals 4 and 5 of the capacitor. The role of the spark gap is twofold. Firstly, it is used as a protective device to prevent overvoltages that could give rise to an electric arc in the space between the two plates 2 and 3 or between the two tubes 8 and 9. A spark gap of this kind enables a passage of current when the difference in voltage at the terminals is greater than a calibrated threshold. Furthermore, the spark gap is used as a circuit for the retrieval of the electrostatic energy stored in the capacitor.

To adjust the apparatus, initially a value β is chosen and a certain number of cycles for the ignition and extinction of the plasma tube is prompted, using the switch 17, to raise the voltage of the terminals 4 and 5, and to collect the energy accordingly. If β is high, a limited number of cycles of the switch 17 is sufficient. If β is low, the number of cycles may be higher, and the growth may be slower and therefore easier to master. The choice of β, the switching frequency of the switch 17, and the voltage of the spark gap are thus factors that make it possible to adapt the power consumed in the load. When this voltage reaches a preset threshold (below a general disruption threshold) the spark gap conducts for a short period of time.

This conduction ensures firstly the consumption of energy produced in the load 24. This load may be a simple resistor, or a motor, especially a motor of a vehicle. The alternating character of the conduction produced by the spark gap may indeed be put to profitable use in order to replace the load by a transformer linked with an AC electric motor. If need be, a part of the energy produced may be used to recharge a battery used as a source 6 and/or as a source 16, before it is used in the load.

Furthermore, the end of the conduction takes place preferably before the charges have been discharged from the plates. In this case, the recharging of the capacitor with plasma tube ignition and extinction cycles can be reproduced without any need to recharge the plates 2 and 3 with the source 6.

A circuit 26 for opening and closing the switch 17 may be a simple variable frequency AC voltage generator driving a relay 17. Preferably, the circuit 26 will comprise a microprocessor controlled as a function of need, or as function of a measurement of the power consumed in the load.

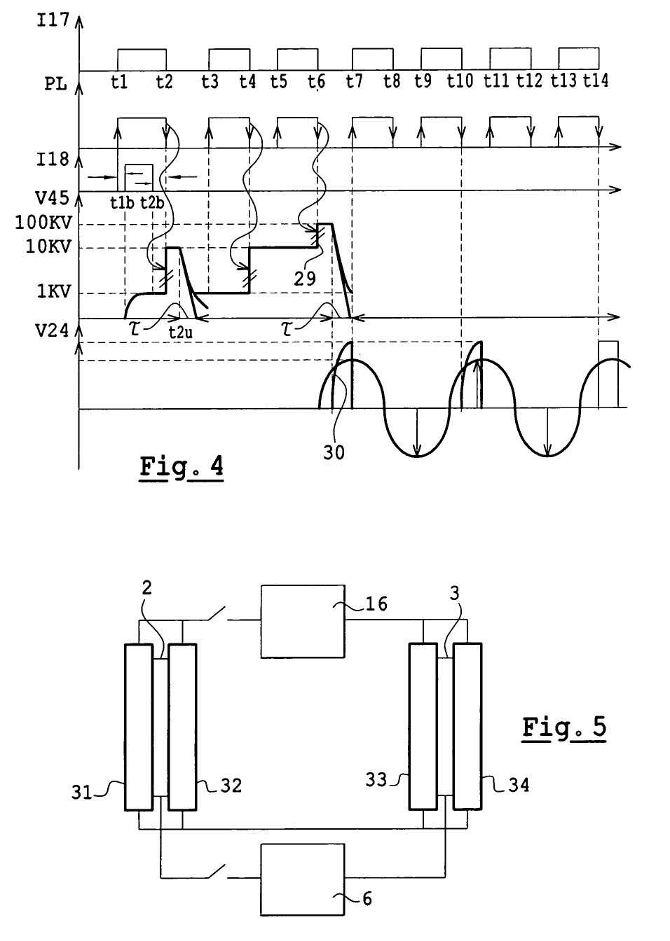

FIG. 4 shows timing diagrams of the electric signals encountered in the device of the invention. A first diagram I17 has the dates t1 to t14 and following dates at which the switch 1 is closed (odd-parity indexes) and then opened (even-parity indexes)). The signal represented is for example the signal produced by the circuit 26. A graph PL shows cases of ionization and de-ionization of the plasma in the tubes 8 and 9 in correspondence with the same dates. A graph I18 shows the closing and then the opening of the switch 18 at the dates t1b and t2b. The date t1b is close to or simultaneous with the date t1. For example it is after (not before) the date t1 by a few microseconds. This quasi-simultaneity can be calibrated by means of a microprocessor 26 that has its rate set at a given frequency, for example more than one MHz, and excites the switch 18 after the switch 17. However, the contrary is possible: only, there would be greater consumption of energy when starting (which is unfavorable to efficiency). The date t2b at which the switch 18 is opened may be postponed. In this case, the switch can even remain closed definitively thereafter. With a definitively closed switch 18, the presence of the diodes such as 27 and 28 playing the role of one-way electric valves in series is indispensable to insulate the source 6 of the high voltage that will arise between the terminals 4 and 5.

A graph V45 shows the voltage present between the plates 2 and 3. At the date t1b, this voltage V45 rises to the value of the voltage given by the direct current source 6. The build-up is of the exponential type owing to the values of the resistance of the source 6 and of the electric connections. At the date t2, the voltage amplification phenomenon takes place suddenly. In one example, the voltage V45 thus goes from 1000 volts to 10,000 volts. The rise is immediate and almost without any detectable time constant.

FIG. 4 actually shows two types of use: a use with immediate consumption of energy and a preferred use with gradual amplification. In the former case, an immediate use of the energy stored in the capacitor C2 is prompted at a date t2u that is after the date t2 but only to a very small extent. For example, in this case, the spark gap 25 is replaced by a switch, and this switch is closed at the instant t2u. In this case, the voltage of the capacitor C2 drops in the load 24, with a time constant T depending on the value of this load and on the value of the capacitor C2.

As was seen further above, for practical embodiments, it is possible that the energy efficiency will not be greater than one. In this case, rather than bringing about an immediate use of the energy, it will be preferred to implement a gradual amplification. To this end, the switch 17 is set at regular pace so that it is alternately closed and opened. Thus, at the date t3, the closing of the switch 17 prompts the ionizing of the tubes as at the date t1. The opening at the date t4 prompts the build-up of the voltage as at the date t2. It will be noted that this phenomenon occurs if a residual voltage is still available in the capacitor C1, after the discharging of this capacitor. This availability can be ensured naturally by a spark gap 25 which ceases to conduct when the voltage at its terminals is below a threshold that is not zero. As a variant, a switch, series-connected between the spark gap 25 and a connection to a terminal 4 or 5 of this spark gap, can be momentarily opened. For example, this opening may be controlled by the microprocessor 26.

In the latter case, at subsequent dates t5 and t6, the ionization and then the de-ionization of the tubes 8 and 9 prompt an additional voltage rise 29. The voltage obtained can then be sufficient for the stored energy to be greater than the charging energy for the different capacitors and tubes, in such a way that the efficiency becomes greater than one. When this very high voltage is available, either the spark gap is activated or a switch enables the load 24 to be connected up. In this case, this circuit is subjected to a voltage pulse 30 of a pulsed signal V24. The duration of the voltage pulse 30 is preferably shorter than the duration between a date t2i (even-parity index) of de-ionization and a date t2i+1 (odd-parity index) of ionization. Under these conditions, the load 24 is subjected to a pulsed mode whose frequency is equal to:
f=1/ (t2i−t2i+4). formula 30

This signal V24 can be introduced into a transformer so that it can be used to control any piece of equipment, especially mobile equipment. In a preferred example, the frequency of the ionization/de-ionization pulses falls within a range of 1 to 10 kHz. It will further be noted that the cyclical ratio of the pulses applied to the tubes 8 and 9 does not need to be half. All that counts essentially from this point of view is constituted by the intrinsic qualities of the gas used in the tubes and the nature of these tubes.

In view of the losses by electric leaks, the efficiency may be affected by the speed with which the operations of ionization/de-ionization are carried out. It has been shown that the phenomenon definitely occurs when the switching frequency of the switch 17 is in the range of 1 kHz or greater than 1 kHz.

Hence, the circuit used to make the conduction device conductive comprises a circuit 26 that needs to be switched over periodically during one or more cycles after the charging of the capacitor. Preferably, in this case, the switched-over voltage generator comprises the switch 18 to disconnect the direct current source 16 for the charging of the capacitor after having charged it for a first time, at least between each group of periodic selection switching cycles.

FIG. 5 shows an alternative embodiment in which the tubes 8 and 9 are duplicated so that each of them has a set of tubes 31 and 32 and 33 and 34 sandwiching the plates 2 and 3 respectively. It can easily be shown that this approach enables the output energy to be doubled for equal efficiency.

The optimizing possibilities of the invention lie in the improvement of the efficiency of the capacitors through the choice of an appropriate dielectric, the maximizing of the distance L between the two plates 2 and 3, and the minimizing of the energy needed to ionize the plasma. This implies the optimizing of the tubes and the pressure of the gas chosen to fill the tubes.

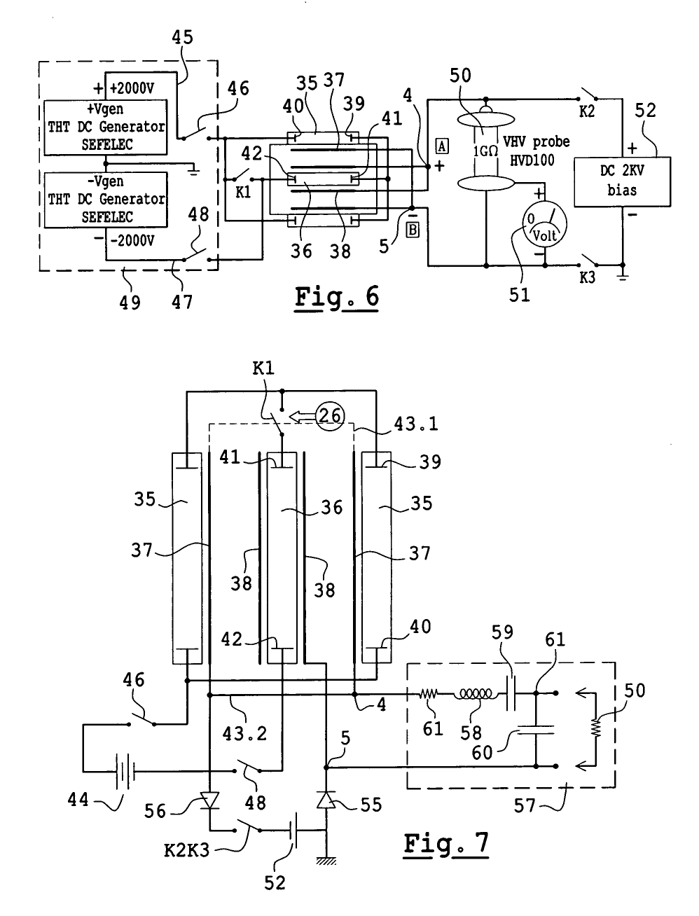

After this first development, in the invention, it was furthermore sought to simplify and perfect the device. A first idea was to make the plasma plates, FIGS. 6 and 7, in the form of a hollow cylindrical plasma ring 35 surrounding a tube forming a hollow plasma mast 36. The cylinder 35 and the mast 36, made of glass or ceramic, or preferably comprising barium titanate, are respectively each coated on their mutually facing surfaces with a metallic film 37 and 38. By their surfaces that face these films, the cylinder 35 and the mast 36 form the plasma plates of the invention. In practice, these metal films 37 and 38 may be aluminum foils directly bonded to the glass of the cylinder 35 or of the mast 36. The chamber formed by the cylinder 35 has two circular electrodes 39 and 40, mounted on either side inside the cylinder and located so as to be facing corresponding electrodes 41 and 42 of the mast 36. The films 37 and 36 form electric sleeves closed on themselves. As an improvement, the film 37 is surmounted by a conductive roof 43.1, connected to the film 37 in the vicinity of the electrode 39, and forming a Faraday cage. At the other end of the assembly, a ring-shaped electrode 40 is connected to a floor 43.2 which itself also forms a Faraday cage. Thus, not all the electromagnetic phenomena that arise in the conductive chamber 37, 43.1 and 43.2 are influenced by electric phenomena external to this chamber. In particular, the parasitic capacitances that result from the presence of the films 37 and 38 or the ionize plasma plates facing any other external conductive device no longer reduce the efficiency of the system. The new solution is of the type described in FIG. 5, in which the plasma plates 32 and 33 would have been removed.

Initially, as can be seen in FIG. 6, the invention was implemented by charging the plasma plates with a balanced power supply 44, connected by its plus pole 45 and by a switch 46 in series, to the electrode 40. By its minus pole 47 and a switch 48 in series, it was connected to the electrode 42, the electrode 39 being furthermore connected to the electrode 41. The available energy was then available at the output: between connections 5 and 4 connected to the films 37 and 38. This energy was recovered at the rate of the switching operations for the switches 46 and 48.

The main utility of the structure thus created is that it introduces the voltage necessary to ionize the plasma plates (in this case the cylinder and the mast). Indeed, this voltage is especially high as the length to be ionized is great, as was the case with the serpentine tubes. However, this reduction in voltage is compensated for by a greater ionization current. Furthermore, owing to the rise in voltage, starting from a low voltage, the risks of electric disruption are reduced.

It was then realized that, when the switches 46 and 48 were open, the plasma in the cylinder 35 and the mast 36 remained ionized, especially at a high voltage in the range of 2000 volts. A second idea then arose of doing without the electric power supply 49 (the one shown in dashes in FIG. 6) and of replacing it by a switch K1 for the series connection of the plasma cylinder 35 with the plasma mast 36. This device works as follows. When the switch K1 is closed, the capacitor is formed by the plasma mast and by the film 38 (very close to the plasma) while another capacitor is formed by the cylinder 35 and the film 37 (which too is very close to the plasma layer). These two capacitors are series-connected because they are connected together by their electrode 39 and 41. They form a capacitor Cmax (corresponding to Cl here above). They are connected by the other terminals to the load. When the switch K1 is open, all that remains is one capacitor Cmin (corresponding to C2 here above), the one formed by the films 37 and 38 which are fairly distant from each other. In this respect, the circuit of FIG. 7 shows a variant of the connection of the switch K1, this switch K1 being now series-connected between the electrode 39 and the electrode 41, instead of being mounted between the electrode 40 and the electrode 42. If need be, the switch K1 may be duplicated into K1 and K′1, one switch being mounted between the electrodes 40 and 42 and the other one being mounted between the electrodes 39 and 41. The switches K1, and/or K′1, form the device for making the system conductive.

In the new approach, everything happens as if the series-connected capacitor were to be formed by the external plasma plates and as if their facing conductive films were to get converted into a single capacitor formed solely by these films. Consequently, the device of the invention can be analyzed as an arrangement of capacitors organized by a switch or selector switch device (46, 48, K1, K′1) forming either a capacitor with two metal plates or a series of capacitors, of which at least two capacitors comprise one of these plasma plates and one of these metal plates. Indeed, it is not ruled out that other arrangements may be provided, in series or in parallel, of more than two of these plasma plates and more than two of these two metal plates.

In this respect, an object of the invention is an electric energy source comprising a capacitor with at least two metal plates facing each other and connected to two terminals of the source, and means to charge this capacitor at a high voltage, wherein the means to charge this metal plate capacitor at high voltage comprise a set of plasma plates positioned so as to be facing these metal plates, these plasma plates being connected to a switch circuit or selector switch circuit to periodically form a set of at least two series-connected capacitors each comprising a metal plate and a plasma plate.

With this device, two phenomena are observed. These phenomena can furthermore be explained in a manner similar to the solution of FIG. 2. Firstly, the remanent ionization of the plasma plates is used to charge the capacitors when they are series-connected. It is then enough to alternately put the switch K1 (and/or K′1) into operation. In this case, the ionization of the gas improves constantly, owing to the increase in the voltage of the facing film Furthermore, this action creates the energy source as described here above.

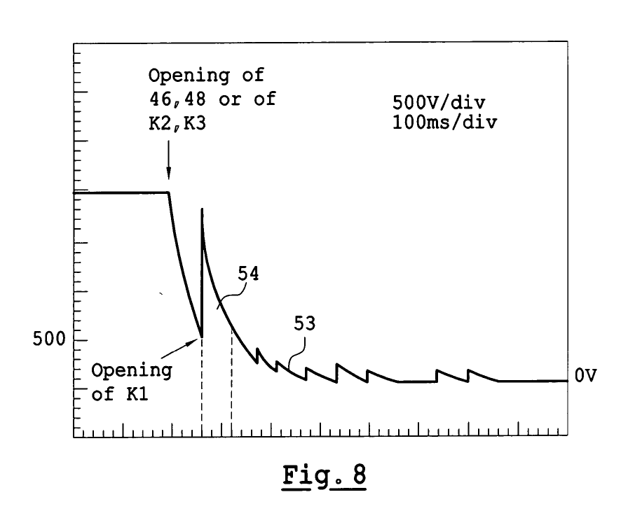

In this experiment, the load connected to the output terminals 4 and 5 comprises a probe at very high voltage THT 50 which, in one example, is equal to 1GW. A voltmeter 51 is connected between a measurement output of this load 50 and a terminal (in this case the terminal 5) of the source. It can be verified in FIG. 8 that the voltage measured by the voltmeter 51 undergoes a considerable increase in its voltage, and thus passes from 500 volts to 1750 volts when the switch K1 is open, and when the system goes from Cmax to Cmin. The discharging of Cmin, which takes about some hundreds of milliseconds, is far slower than the phenomenon of the increase in voltage which is not perceptible and takes less than one millisecond. The de-excitation of the plasma occurs as soon as the switches 46 are open.

However, in the case of this improvement, the plasma plates 35 and 36 are excited at the outset directly only by the application of high voltages to the electrodes 40 and 42. They are excited by induction from a high voltage source 52 connected by switches K2 and K3 directly to the outputs 4 and 5. It can be shown that the power supply voltage 52 which, in one example, is equal to 2000 volts, is half of what was necessary with the power supply 49 to obtain the same result. With this improvement, the need for the power supply 49 is completely done away with.

It is observed, if only with the drawing of FIG. 8, that a supplement of dissipated energy is available. Indeed, the energy dissipated in the probe 50 directly corresponds to the integral of the surface located beneath the discharge curve 53. This energy which can be dissipated includes the area 54 which results only from the opening of the switch K1, without any addition of energy.

To make the system work productively, it is enough to close this switch K1 again before the voltage level has excessively fallen back, for example, as soon as it has reached 1000 volts, and then open it immediately so that the voltage goes to 3500 volts (instead of going from 500 to 1750 in the preceding step). In one embodiment, once the plasma has been ignited, and while the switches K2 and K3 remain open, it is enough to switch over the switch K1, with a frequency corresponding to the desired power throughput rate.

To simplify the process of putting into operation, it is planned to replace the switches K2 and K3 with diodes 55 and 56 (FIG. 7) respectively. A switch K2 K3 for putting the system into operation can be maintained. These diodes 55 and 56 serve to maintain an acceptable starting voltage (2000 volts in the example). A service voltage between the metal films can be defined as the one in which the plasmas get regenerated by the closing of the switch K1. In the example, as soon as this service voltage becomes greater than 2000 volts, the diodes play their role of switch. The system is even simpler. It is not necessary to command these switches K2 K3. It will furthermore be noted that it is preferable to position two switches (or two diodes) in series on either side of the power supply to preserve the symmetry. If this is not the case, there is a risk of failing to implement the invention.

With regard to the value Cmax, and hence the Cmax/Cmin efficiency, it will be noted that they depend on the ionization of the plasma. At higher voltage, for example if the power supply 52 is 4000 volts, the ionization will be far greater, and the ratio of 3.5 obtained (500/1750) will be modified into a far higher ratio (for example it could be equal to 8) and the voltage available at the probe 50 would then be taken to 8×4000 volts, giving 32 000 volts. It is therefore necessary to be careful with the initial voltages, and the selection switching frequencies involved.

To resolve a possible problem resulting from these overvoltages which might exceed the disruption voltages of the devices, an attenuator circuit is provided. The circuit is shown as a load 57 in FIG. 7. This circuit 57 has an inductor 58 series-connected with a capacitive voltage divider formed by two capacitors 59 and 60. The real load 50 is connected to the terminals of the capacitor 60, between the terminal 5 and the midpoint 61 of the capacitive divider.

Furthermore, it can be the case that the power supply 52 (or 49) is necessary only for the starting. It could even be imagined that the source of the invention, when it comes out of the production plant, is given a voltage that is already precharged and proper to an instantaneous throughput rate at request. The basic device therefore does not necessarily have this power supply 52 (or 49).

For the regulation of the operation, the switch K1 (and/or K′1) is controlled by a circuit 26 producing an alternating signal. The control signal produced by the circuit 26 takes account of the need for power. For example, a voltmeter is mounted at the terminals of the load. If the voltage of the terminals of the voltmeter drops, the circuit 26 provides for an increase in frequency and the production of greater energy. If not, the frequency must be lowered. The relationship between the voltage and frequency may furthermore not be linear. The circuit 26 preferably has a microprogrammed microprocessor that sets up this relationship.

The efficiency of the system can be estimated more precisely by observing that the charge Q localized on the plate of a capacitor is also the charge forming the current that flows in the plasma tubes. Consequently, the energy consumed by the voltage Vs source 44 is Es=QVs while the electrostatic energy for the charging of the capacitors has the value E1=QV1/2. The efficiency of the system is therefore:
a=bV1/2(V1+Vs) formula 31

The above formula shows that it is necessary to choose a charging voltage of C1 (Cmax) greater than or equal to the operating voltage of the plasma tubes to obtain efficiency greater than 1. Consequently, the choice of an accordion-like plasma tube where the length of the tubes is great is not the configuration best suited to obtaining high efficiency. It is therefore more appropriate to choose full plasma panels where the length of the plasma to be ionized will be equal to the height of the plates shown in FIGS. 6 and 7.

The cylindrical configurations shown in FIGS. 6 and 7 enable this condition to be achieved practically. Furthermore, this configuration makes it possible to obtain a Faraday cage to isolate the internal electric field defined between the metal plates of the external electric field prevailing in the plasma, in order to prevent an undesired re-ignition of the plasma. It is possible to considerably simplify the configuration of FIGS. 6 and 7 by eliminating the supply to the plasma tubes and using the external electric fields to ionize the plasma during the charging of the capacitor. In this case, it is enough to place a switch between the wires that connect the internal and external tubes to produce the variation of capacitance.

The system for the shaping and retrieval of energy to supply the external load comprises a capacitor divider delayed by the presence of an inductor 58. The RLC system, respectively 61, 58, and 59-60, of this capacitive divider is tuned in sub-critical mode in such a way that, during the charging of Cmax and the modification of the capacitance of Cmax to Cmin, the charging current of the capacitor 59-60 will be almost zero.

A physical explanation can be given for the energy gain if it is assumed that one of the metal plates is connected in certain way to the Earth whose potential Vp is not zero, contrary to the assertions often made in the literature on the subject, but amounts to several millions of volts in relation to the ionosphere. As a consequence, the formula giving the electrostatic energy of the capacitor coupled to the Earth comprises an additional term related to the capacitance Cp=700 microfarad proper to the Earth:
Ep=Q²/2C+Cp(Vp−V/2)²/2 formula 32

When the mutual capacitance C falls, the charge Q=CV being constant, the first term in the above equation increases along with the corresponding voltage V. This implies a reduction of the potential energy of the Earth associated with the second term in the above formula. The general law of conservation of energy is therefore met.

1. An electric energy source comprising:
a capacitor with at least two metal plates facing each other and connected to two terminals of the source, and
means to charge this capacitor at a high voltage,
wherein the means to charge this metal plate capacitor at high voltage comprise:
a set of plasma plates positioned so as to be facing these metal plates,
these plasma plates being connected to a switch circuit or selector switch circuit to periodically form a set of at least two series-connected capacitors each comprising a metal plate and a plasma plate.

2. A source according to claim 1, wherein:
the plasma plates comprise a hollow cylindrical ring and a hollow tube forming a hollow mast inside the cylindrical ring.

3. A source according to claim 2, wherein:
the metal plates are formed by films placed flat against the ring and the mast.

4. A source according to one of the claims 1 to 3, wherein connections for linking metal plates or plasma plates form a Faraday cage of the source with the plates.

5. An electric energy source comprising:
a capacitor with two plates connected to two terminals of the source,
a conduction device interposed between the two plates, comprising:
a switch circuit or selector switch circuit to make the conduction device conductive or non-conductive.

6- A source according to one of the claims 1 to 4, wherein:
the conduction device and/or the plasma plates comprise a gas contained in a chamber,
the switch circuit or selector switch circuit to make the device conductive comprises a circuit to excite the gas and convert it into plasma.

7- A source according to one of the claims 1 to 5, wherein:
the circuit to excite the gas comprises a set of electrodes, an electric power supply and a circuit to periodically apply an electrical power supply voltage to the electrodes.

8- A source according to one of the claims 1 to 6, wherein
the circuit to excite the gases comprises a set of metal plates, an electric power supply and a circuit to periodically apply a voltage to the plasma plates by induction.

9- A source according to one of the claims 6 to 7, wherein the frequency of periodic application is greater than or equal to 1 kHz.

10- A source according to one of the claims 1 to 8, comprising:
a circuit for the charging and a circuit for the discharging of the plate capacitor,
the charging circuit comprises a direct-current electrical power supply insulated from the discharging circuit by a one-way electric valve in series, preferably a set of diodes placed on either side of the supply.

11- A source according to one of the claims 1 to 9, comprising:
a circuit for discharging the plate capacitor,
the discharging circuit comprises a spark gap in series with a resistive load.

12- A source according to one of the claims 1 to 10, wherein
the switch circuit or selector switch circuit to make the conduction device conductive or non-conductive comprises a switched voltage generator.

13- A source according to claim 11, wherein the switched voltage generator comprises a circuit to be switched over periodically during one or more cycles after the capacitor has been charged.

14- A source according to claim 12, wherein the switched voltage generator comprises a circuit to disconnect a continuous source for the charging of the capacitor after having charged said capacitor.

15- A source according to one of the claims 12 to 13, wherein the switched voltage generator is a variable frequency generator.

16- A source according to claim 14, wherein the variable frequency of the generator is adjusted as a function of the value of a resistive load connected to the terminals of the source.

17- A source according to one of the claims 1 to 15, wherein:
the conduction circuit comprises glass or ceramic tubes, preferably doped with barium titanate.

18- A source according to one of the claims 1 to 16, wherein the gas is argon or any other gas or a mixture of rare gases.
